(19) United States
(12) Patent Application Publication
(10) Pub. No.: US 2022/0217191 A1
(43) Pub. Date: Jul. 7, 2022

(54) METHOD AND DEVICE TO MANAGE AUDIO AND/OR VIDEO SOURCES DURING A STREAMING SESSION

(71) Applicant: Lenovo (Singapore) Pte. Ltd., New Tech Park (SG)

(72) Inventors: Mark Patrick Delaney, Raleigh, NC (US); Russell Speight VanBlon, Raleigh, NC (US); John Carl Mese, Cary, NC (US); Nathan J. Peterson, Oxford, NC (US); Arnold S. Weksler, Raleigh, NC (US)

(21) Appl. No.: 17/140,288

(22) Filed: Jan. 4, 2021

(51) Int. Cl. H04L 29/06; H04L 12/28

(52) U.S. Cl. CPC H04L 65/4084; H04L 12/282; H04L 12/2814; H04L 65/4007

(57) ABSTRACT

A computer implemented method, device and computer program device are provided establish a streaming session between an electronic device (ED) and output devices(s) to stream AV content from a first AV source. When a second application attempts to change the AV source to a second AV source, it is determined whether to permit or deny the change based on at least one of the following criteria: i) whether the second AV application is designated to be a private or public type of AV application, ii) whether the first and second applications are different or similar in type, iii) whether the AV output devices are a private type, or iv) whether an environment awareness model indicates that the change should be permitted or denied. The streaming session is managed the first AV source or change to the second AV source based on the determining operation.

### BACKGROUND

Embodiments herein generally relate to methods and devices that manage changes between audio/video sources during a streaming session with a public output.

Today, electronic devices are enabled to interact with one another in a wide variety of manners including the ability to share audio and/or video content. For example, smart phones, tablet devices, laptop computers and the like are able to stream audio/video content to other devices (e.g., utilizing a Bluetooth or other Wi-Fi connection). However, when a portable electronic devices utilized to stream AV content from an active AV source to one or more AV output devices that are separate from the ED, a potential exists for undesirable events to occur, in the event the user of the portable electronic device opens another application. For example, an individual (host) may have various guest at their home. The host may stream music from the host's smart phone, tablet device or other portable electronic device to a Bluetooth enabled speaker, Sonos system or other wireless stereo system in the host home for entertainment.

The host may want to step away from the guest and undertake a private matter utilizing the host phone, such as view highlights of a sporting event on his/her phone, accept a Facetime phone call from his/her daughter, receive a work related phone call, listen to a voicemail, view a video from a social media account and the like. If the user forgets that the device is connected to a stereo or smart TV, when the user opens the sports application, answers the FaceTime phone call or otherwise, the portable electronic device stops streaming music to the stereo and begins playing the private audio content related to the new application that the host has opened (e.g., sports announcer commentary from the highlights, daughters FaceTime call, work phone call, voicemail, etc.). The portable electronic device may stream the private audio content over the home entertainment system, unbeknownst to the host, which may present a very undesirable user experience.

Alternatively, some individuals will know what will happen if the host opens the second application. In the event that the host desires to utilize the portable electronic device for another reason, the host must disconnect the smart phone from the AV output devices before opening the second application. Still, a potential remains that the user may not correctly disconnect the prior streaming session, or the portable electronic device may reestablish a streaming session automatically. The user may begin to have a conversation that he/she believes to be private, but is actually broadcasts to the guest.

Accordingly, a need remains for methods and devices that manage streaming sessions to avoid undesirable changes in an audio source.

### SUMMARY

In accordance with embodiments herein, a method is provided that comprises, under control of one or more processors configured with executable instructions that include first and second applications; operating the first application on an electronic device (ED), the first application providing a first audio/video (AV) source; establishing a streaming session between the ED and one or more AV output devices, the streaming session streaming AV content, to the one or more AV output devices, from the first AV source designated by the first application operating on the ED; accessing the second application on the ED, the second application providing a second AV source; identifying an attempt, by the second application, to change the AV content from the first AV source associated with the first application to the second AV source associated with the second application; determining whether to permit or deny the change to the second AV source based on at least one of the following criteria: i) whether the second AV application is designated, in settings of the ED, to be a private or public type of AV application, ii) whether the first and second applications are different or similar in type, iii) whether the one or more AV output devices are a private type of output device, or iv) whether an environment awareness model indicates that the change should be permitted or denied; and managing the streaming session to maintain the first AV source or change to the second AV source based on the determining operation.

Additionally or alternatively, the method displays at least one of: 1) a notice-only prompt or 2) a notice-response prompt on a graphical user interface of the ED, the notice-only prompt presenting at least one of: i) a message indicative of the change to the second AV source, or ii) an identification of the one or more AV output devices that will output the AV content from the second AV source, the notice-response prompt including a response field for an input to permit or deny the change. Additionally or alternatively, the determining operation includes determining that the second AV application is designated, in settings of the ED, to be the private type of AV application, and based thereon, the managing operation maintaining the first AV source and denying the change to the second AV source. Additionally or alternatively, the determining operation includes determining that the first and second applications are different in type, and based thereon, the managing operation maintaining the first AV source and denying the change to the second AV source. Additionally or alternatively, the determining operation includes determining that the one or more AV output devices are a private type of output device, and based thereon, the managing operation including permitting the change to the second AV source.

Additionally or alternatively, the determining operation includes determining that the environmental awareness model indicates that the change should be denied, and based thereon, the managing operation maintaining the first AV source and denying the change to the second AV source. Additionally or alternatively, the AV content includes only audio content, with no video content. Additionally or alternatively, the AV content includes only video content, with no audio content.

In accordance with embodiments herein, an electronic device is provided that comprises: a processor; a user interface; a data storage device having executable instructions and first and second applications accessible by the processor; wherein, responsive to execution of the instructions, the processor to: operate the first application to provide a first audio/video (AV) source; establish a streaming session between the ED and one or more AV output devices, the streaming session streaming AV content, to the one or more AV output devices, from the first AV source designated by the first application; access the second application having a second AV source; identify an attempt, by the second application, to change from the first AV source associated with the first application to the second AV source associated with the second application; determine whether to permit or deny the change to the second AV source based on at least one of the following criteria: i) whether the second AV application is designated, in settings of the ED, to be a private or public type of AV application, ii) whether the first and second applications are different or similar in type, iii) whether the one or more AV output devices are a private type of output device, or iv) whether an environment awareness model indicates that the change should be permitted or denied; and manage the streaming session to maintain the first AV source or change to the second AV source based on the determining operation.

Additionally or alternatively, the user interface is configured to display at least one of: 1) a notice-only prompt or 2) a notice-response prompt on a graphical user interface of the ED, the notice-only prompt presenting at least one of: i) a message indicative of the change to the second AV source, or ii) an identification of the one or more AV output devices that will output the AV content from the second AV source, the notice-response prompt including a response field for an input to permit or deny the change. Additionally or alternatively, the executable instructions are executable by the processor to determine that the second AV application is designated, in settings of the ED, to be the private type of AV application, and based thereon, to maintain the first AV source and denying the change to the second AV source. Additionally or alternatively, the executable instructions are executable by the processor to determine that the first and second applications are different in type, and based thereon, to maintain the first AV source and denying the change to the second AV source. Additionally or alternatively, the executable instructions are executable by the processor to determine that the one or more AV output devices are a private type of output device, and based thereon, to permit the change to the second AV source.

Additionally or alternatively, the executable instructions are executable by the processor to determine that the environmental awareness model indicates that the change should be denied, and based thereon, to maintain the first AV source and deny the change to the second AV source. Additionally or alternatively, the AV content includes only audio content, with no video content.

In accordance with embodiments herein, a non-signal readable data storage device is provided that comprises executable code to: operate a first application to provide a first audio/video (AV) source; establish a streaming session between the ED and one or more AV output devices, the streaming session streaming AV content, to the one or more AV output devices, from the first AV source designated by the first application; access the second application having a second AV source; identify an attempt, by the second application, to change from the first AV source associated with the first application to a second AV source associated with the second application; determine whether to permit or deny the change to the second AV source based on at least one of the following criteria: i) whether the second AV application is designated, in settings of the ED, to be a private or public type of AV application, ii) whether the first and second applications are different or similar in type, iii) whether the one or more AV output devices are a private type of output device, or iv) whether an environment awareness model indicates that the change should be permitted or denied; and manage the streaming session to maintain the first AV source or change to the second AV source based on the determining operation.

Additionally or alternatively, the executable code manages display of at least one of: 1) a notice-only prompt or 2) a notice-response prompt on a graphical user interface of the ED, the notice-only prompt presenting at least one of: i) a message indicative of the change to the second AV source, or ii) an identification of the one or more AV output devices that will output the AV content from the second AV source, the notice-response prompt including a response field for an input to permit or deny the change. Additionally or alternatively, the executable code determines that the second AV application is designated, in settings of the ED, to be the private type of AV application, and based thereon, the manage operation to maintain the first AV source and denying the change to the second AV source. Additionally or alternatively, the executable code determines that the first and second applications are different in type, and based thereon, to maintain the first AV source and denying the change to the second AV source. Additionally or alternatively, the executable code determines that the environmental awareness model indicates that the change should be denied, and based thereon, to maintain the first AV source and deny the change to the second AV source.

### BRIEF DESCRIPTION OF THE DRAWINGS

FIG. 1 illustrates a system for selecting an audio output circuit based on priority attributes in accordance with embodiments herein.

FIG. 2 illustrates a simplified block diagram of a base device of FIG. 1 in accordance with an embodiment.

FIG. 3 illustrates a process for managing changes between audio/video sources during real-time streaming to a public AV output device in accordance with embodiments herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

It should be clearly understood that the various arrangements and processes broadly described and illustrated with respect to the Figures, and/or one or more individual components or elements of such arrangements and/or one or more process operations associated of such processes, can be employed independently from or together with one or more other components, elements and/or process operations described and illustrated herein. Accordingly, while various arrangements and processes are broadly contemplated, described and illustrated herein, it should be understood that they are provided merely in illustrative and non-restrictive fashion, and furthermore can be regarded as but mere examples of possible working environments in which one or more arrangements or processes may function or operate.

### Terms

The terms “audio/video” and “AV” shall mean audio and/or video and shall include audio only, video only, or a combination of audio and video. For example, AV content may include 1) only audio content, with no video content 2) only video content, with no audio content, or 3) a combination of audio and video content. As another example, an AV output device may include a device to 1) output only audio content, and not video content, 2) output only video content, and not audio content, or 3) output a combination of audio and video content. As another example, an AV source may represent 1) a source that provides audio content but does not provide video content, 2) a source that provides video content but does not provide audio content, or 3) a source that provides both audio and video content.

The term “environment awareness model” refers to a model that takes into consideration information indicative of a condition present in an environment in which one or more electronic devices are located. Nonlimiting examples of information considered by the environment awareness model include a proximal range of a base electronic device with respect to an AV output device. The environment awareness model may also consider information that includes an indication of a presence of other individuals and/or third-party electronic devices within the environment, a change in location (e.g., room) by an ED and the like.

The term “digital personal assistant”, “DPA”, “virtual assistant”, “intelligent digital assistant”, as used throughout, shall generally refer to any electronic device that has a user interface or information processing system that uses a voice recognition system, such as a Natural language understanding (NLU), automatic speech recognition (ASR), or text-to-speech synthesis (TTS), to interpret natural language input in spoken form and/or textual form to infer intent, and perform actions based on an inferred user intent. For example, a digital personal assistant may receive a user instruction in the form of a natural language command, request, statement, narrative, and/or inquiry. A user instruction may seek either an informational answer or performance of a task by the digital personal assistant. Accordingly, the digital personal assistant can perform the requested task and/or provide responses in audio and/or visual form, such as natural language, music, video, text, animations, etc.

The term “environment” refers to a physical region in which one or more electronic devices and AV output devices are located and in which AV content output by the AV output device(s) is perceived (e.g., heard, seen, felt) by individuals. By way of example, an environment may refer to one or more rooms within a home, office or other structure. An environment may or may not have physical boundaries. For example, an environment instead be defined based upon a range over which individuals may perceive actions by electronic devices. For example, an environment may refer to one or more of a pool area, a deck on a house, a backyard, an exterior area outside of an office building, a commercial area and the like, where approximate virtual boundaries of the environment correspond to the range over which actions by electronic devices may be heard, seen, felt or otherwise perceived. When an electronic device is portable and/or handheld, an environment associated with the electronic device may shift over time when the electronic device is moved. For example, an environment surrounding a smart phone, tablet device or laptop computer moves with the smartphone, tablet device or laptop computer. An environment surrounding a DPA device will shift each time the DPA device is relocated, such as when moved between different rooms of a home, office building or other residential or commercial structure.

The term “environment related action” refers to actions performed by one or more electronic devices that are perceived by all or some of the individuals within a corresponding environment. Nonlimiting examples of environment related actions include playing music, movies, television programming or other audio and/or video entertainment content, instructional content, work related content and the like.

The terms “stream” and “streaming” shall mean constantly sending/receiving content over a wireless connection between two or more devices based on a predetermined protocol, such as but not limited to a Bluetooth protocol. A streaming operation may be between two individual devices (e.g., as in a point-to-point connection), and/or from a base electronic device to multiple output device first and second applications 106, 107. The first and second es (e.g., as in a point to multipoint connection).

### Overview

In accordance with new and unique aspects herein, methods and systems are provided to manage transition between different AV sources associated with different applications operating on an electronic device that is streaming AV content from an active AV source to one or more AV output devices that are separate from the ED. As an example, an individual (host) may have a number of guest at his/her home. The host may stream music from the host's smart phone, tablet device or other portable electronic device to a Bluetooth® enabled speaker, Sonos® system or other wireless stereo system in the host home for entertainment. The host may step away from his/her guest and need to utilize the portable electronic device for another reason. For example, the host may view highlights of a sporting event on his/her phone, accept a Facetime® phone call from his/her daughter, receive a work related phone call, listen to a voicemail, view a video from a social media account and the like. In conventional systems, the portable electronic device would stop streaming music to the home stereo system and automatically begin playing, over the speaker or home entertainment system, the private audio content related to the new application the host has opened (e.g., sports announcer commentary from the highlights, daughter's call through the FaceTime® application, work phone call, voicemail, etc.). The portable electronic device would stream the private audio content over the home entertainment system, unbeknownst to the host, which may present a very undesirable user experience.

In accordance with new and unique aspects herein, methods and devices are provided that identify when a second application attempts to change an AV source for streaming content. Various criteria are described herein to manage a response to the attempt to change the AV source. For example, embodiments herein determine whether to permit or deny the change to the second AV source based on at least one of the following criteria: i) whether the second AV application is designated, in settings of the ED, to be a private or public type of AV application, ii) whether the first and second applications are different or similar in type, iii) whether the one or more AV output devices are a private type of output device, or iv) whether an environmental model indicates that the change should be permitted or denied. Based on the criteria, the portable electronic device manages the streaming session to either i) maintain the first AV source or ii) change to the second AV source based on the determining operation.

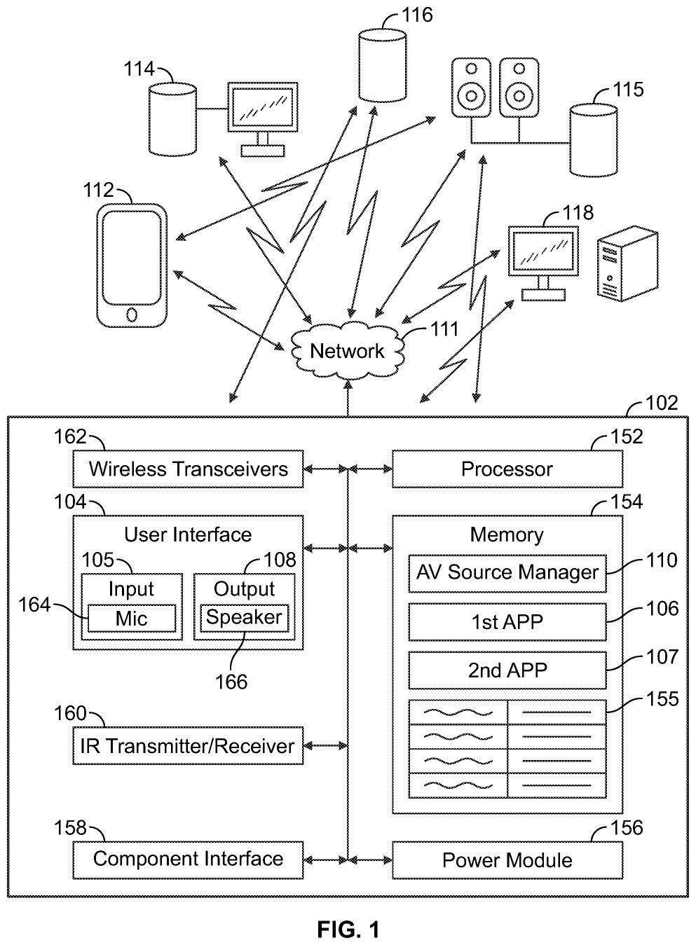

FIG. 1 illustrates a system 100 for managing streaming AV content between an electronic device and one or more AV output devices in accordance with embodiments herein. The system 100 includes an electronic device (ED) 102, that may also be referred to as a base ED, that is configured to implement various applications on the ED, as well as to stream AV content. The electronic device 102 streams AV content and otherwise communicates with AV output devices 112-116. The AV output devices 112-116 may represent various types of devices, such as a smart phone 112, an electronic device 114-116 having digital personal assistant (DPA) functionality, a smart TV or desktop computer. For example, the AV output devices 114-116 may represent an Amazon Echo® device, Google Home device, and the like.

The ED 102 may stream AV content to or otherwise communicate with one or more of the AV output devices 112-116 over a network 111, such as through a wireless transceiver 162. Additionally or alternatively, the electronic device 102 may stream AV content and otherwise communicate with one or more of the AV output devices 112-116 directly through a point-to-point communications link, such as in accordance with the Bluetooth protocol. A streaming operation may be between two individual devices 102, 116 (e.g., as in a point-to-point connection), and/or from a base electronic device 102 to multiple AV output devices 114-116 (e.g., as in a point to multipoint connection). When a direct communications link is maintained between electronic devices, the network 111 may be bypassed or removed entirely.

As shown in FIG. 1, the electronic device 102 includes components such as one or more processors 152 (e.g., a microprocessor, microcomputer, application-specific integrated circuit, etc.), one or more local storage medium (also referred to as a memory) 154, a user interface 104 which includes one or more input circuits 105 and one or more output circuits 108, a power module 156, a component interface 158, an infrared (IR) transmitter/receiver 160 and one or more wireless transceivers 162. All of these components can be operatively coupled to one another, and can be in communication with one another, by way of one or more internal communication links, such as an internal bus.

The input circuit 105 receives user instructions in various manners, such as through touching a graphical user interface, using a facial recognition application, using voice recognition (VR) application 106 and the like. The processors 152 execute instructions stored in the memory 154 to interpret and perform actions based on user instructions that are received through the input circuit 105. The user instruction may represent requests of various types. By way of example, in connection with managing a streaming session while switching between first and second applications, the GUI may display at least one of: 1) a notice-only prompt or 2) a notice-response prompt on a graphical user interface of the ED, the notice-only prompt presenting at least one of: i) a message indicative of the change to the second AV source, or ii) an identification of the one or more AV output devices that will output the AV content from the second AV source, the notice-response prompt including a response field for an input to permit or deny the change.

The memory 154 may encompass one or more memory devices of a variety of forms (e.g., read only memory, random access memory, static random access memory, dynamic random access memory, etc.) and can be used by the processor 152 to store and retrieve data. The data that is stored by the memory 154 can include, but need not be limited to, operating systems, applications, user collected content, and informational data. Each operating system includes executable code that controls basic functions of the device, such as interaction among the various components, communication with external devices via the wireless transceivers 162, the component interface 158, and/or the IR transmitter/receiver 160, and storage and retrieval of applications and data to and from the memory 154. Each application includes executable code that utilizes an operating system to provide more specific functionality for the communication devices, such as file system service and handling of protected and unprotected data stored in the memory 154.

The memory 154 is configured to store, among other things, first and second applications 106, 107 that, when active and operating, provide first and second audio/video sources, respectively. The first application 106 may be operated on the ED 102 to provide the first AV source which is streamed from the wireless transceiver 162 to one or more of the AV output devices 112-116. The wireless transceiver 162 establishes a streaming session between the ED 102 and one or more of the AV output devices, in order that the streaming session is able to stream AV content from the first AV source designated by the first application 106. As explained herein, the ED 102 may access the second application 107 in response to various factors, such as a selection on the GUI by the user, and incoming notification or request from an external source (e.g., phone call, notification through an Instagram application).

An AV source manager 110 is provided to manage transitions between AV sources. Among other things, the AV source manager identifies attempts by inactive or secondary applications, such as the second application 107, to change the source for AV content, to be streamed, from the first AV source associated with the first application 106 to the second AV source associated with the second application 107. The AV source manager 110 determines whether to permit or deny the change to the second AV source based on at least one of the following criteria: i) whether the second AV application is designated, in settings of the ED, to be a private or public type of AV application, ii) whether the first and second applications are different or similar in type, iii) whether the one or more AV output devices are a private type of output device, or iv) whether an environmental model indicates that the change should be permitted or denied. The AV source manager 110 manages the streaming session to maintain the first AV source or change to the second AV source based on the determining operation.

Additionally or alternatively, in connection with determining whether to permit or deny a change, the AV source manager 110 may determine that the second AV application is designated, in settings of the ED, to be the private type of AV application, and based thereon, the managing operation maintaining the first AV source and denying the change to the second AV source. Additionally or alternatively, the AV source manager 110 may further determine that the first and second applications are different in type, and based thereon, the managing operation maintaining the first AV source and denying the change to the second AV source. Additionally or alternatively, the AV source manager 110 may further determine that the one or more AV output devices are a private type of output device, and based thereon, the managing operation maintaining permitting the change to the second AV source. Additionally or alternatively, the AV source manager 110 may further determine that the environmental model indicates that the change should be denied, and based thereon, the managing operation maintaining the first AV source and denying the change to the second AV source.

As explained herein, the AV content may include only audio content, with no video content. As another option, the AV content may include only video content, with no audio content. As another option, the AV content may include both audio and video content.

An environment awareness (EA) model 110 identifies environment awareness information concerning an environment in which an environment related action is to be performed. The EA model 110 obtains awareness information for regions and/or multiple environments. For example, the EA model 110 obtains awareness information for separate regions or environments each of which correspond to AV output devices 112-116. The EA model 110 utilizes the information to determine whether a change in the AV source should be permitted or denied. For example, the EA model 110 may take in consideration a range or distance between the base ED and the AV output device. Additionally or alternatively, the EA model 110 may take in consideration whether the base ED 102 (and its user) have moved to a different room separate from the room or rooms in which the AV output device(s) are playing. Additionally or alternatively, the EA model 110 may take in consideration whether other devices (and corresponding users) are present within the environment in which the output of the AV output devices may be seen or heard. Additionally or alternatively, the EA model 110 may include (and optionally be limited to) presenting a prompt or warning message on the user interface of the base ED. The prompt may indicate that the AV source is about to change to present AV content associated with the second application. The prompt may request a user input to permit or deny the change.

The electronic device 102 includes an output circuit 108 and transceiver 202, one or both of which may output incoming and/or modified user instructions to the collection of responsive electronic devices. The electronic device 102 includes a voice recognition type user interface and is configured to access the network 111 over a wired or wireless connection. As non-limiting examples, the electronic device 102 may access the network 111 through a wireless communications channel and/or through a network connection (e.g., the Internet). Additionally or alternatively, the electronic device 102 may be a wired or wireless communication terminal, such as a desktop computer, laptop computer, network-ready television, set-top box, and the like.

One or more of the AV output devices 112-116 may represent the same type or different types of device as the electronic device 102, and/or a speaker, home theater system, computer, mobile phone, television, communication content player, smart watch, smart TV and the like. For example, an auxiliary output may be used to form a wired connection. Optionally, a Bluetooth link or other wireless link may for a direct connection wirelessly.

The electronic device 102 is configured to access network resources 118, including web-based or network-based data, applications, and services, via the network 111. The network 111 may represent one or more of a local area network (LAN), a wide area network (WAN), an Intranet or other private network that may not be accessible by the general public, or a global network, such as the Internet or other publicly accessible network. The network 111 provides communication between the electronic device 102 and one or more network resources 118. It will be understood that, in some embodiments, the network resources 118 may represent a single entity or one or more physical or virtual servers that are configured to deliver online resources to the electronic device 102. Examples of the network resources 118 include, but are not limited to, web-based or network-based data storage services, social networking applications, shopping services, payment services, multimedia content delivery services, financial services and the like. The resources 118 may represent a Web service or a network service for an e-commerce business, financial institution, or any other commercial, noncommercial, personal, nonprofit or other entity.

The user interface 104 permits the user to operate the electronic device 102 for any of its intended purposes, such as administering the EA model 110, defining individual applications as private or public, establishing and terminating streaming sessions, providing input to a notice-response prompt, operating software applications, electronic communication, listening to audio media, and the like. The input circuit 105 can include one or more audio input circuits, such as a microphone 164 that is configured to receive audio input (e.g., instructions, requests) from the user. The output 108 can include one or more electronic devices, such as a speaker 166, that are configured to communicate notification alerts or notification content to the user.

Optionally, the input and output circuits 105, 108 may each include a variety of visual, audio, and/or mechanical devices. For example, the input circuit 105 can include a visual input device, such as an optical sensor or camera, and/or a mechanical input circuit such as a keyboard, keypad, selection hard and/or soft buttons, switch, touchpad, touch screen, icons on a touch screen, a touch sensitive areas on a touch sensitive screen and/or any combination thereof. Similarly, the output circuit 108 can include a visual output circuit such as a liquid crystal display screen, touch sensitive screen, a non-touch sensitive screen, a text-only display, a smart phone display, an audio output (e.g., a speaker or headphone jack), and/or any combination thereof and/or one or more light emitting diode indicators. The output circuit 108 is integral to (e.g., within a common housing) the electronic device 102.

The processor 152 identifies the availability of AV output devices 112-116 operatively connected to the electronic device 102. For example, the processor 152 can direct the transceiver 162 to transmit an availability inquiry request and listen for responses from the AV output devices 112-116. The processor 152 analyzes availability data from the responses to obtain information indicative of the availability of each electronic device. Optionally, the processor 152 analyzes data from the responses to obtain additional information about each audio device, such as the manufacturer, make, model, version of the device.

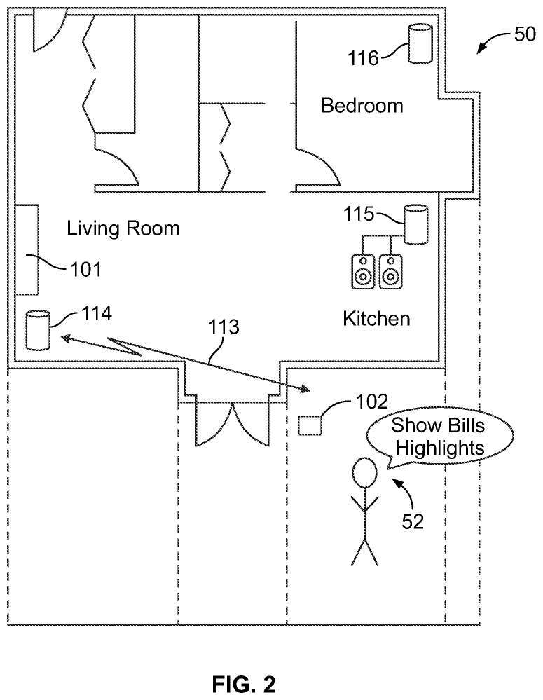

FIG. 2 illustrates a top plan view of an environment in which embodiments herein may be implemented. The environment 50 may represent a home, office, or other structure. In the example of FIG. 2, the environment 50 represents a home with an outdoor exterior region 52, a living room region, kitchen region and bedroom region. The electronic device 102 and AV output devices 114-116 are shown at representative locations distributed throughout the environment 50. For example, the individual may have guested within the environment 50 and may desire to play music or video content to the guests. To do so, and AV application is opened on the electronic device 102 which then streams music for a music application to the AV output device 114 over a direct wireless link 113. The AV output device 114 then may redistribute the same AV content to the AV output devices 115 and/or 116, such as through direct links or over a local area network. Additionally or alternatively, the electronic device 102 may be configured to stream mirrored/shared video to a smart television 101 (or to AV output device 114 which is connected to a regular television).

The user of the electronic device 102 may step outside to take a work or personal phone call. Alternatively, the user of the electronic device 102 may wish to check the highlights of a sporting event and thus may step outside to do so. The user may direct a verbal user instruction to local electronic device 102, such as “Show me Highlights of Bills Game”. As explained herein, before blindly opening a sports application and playing the audio playing the music over every electronic device attached to a network, the electronic device 102 implements the operations described herein to collect various criteria, and based on the criteria determine whether to permit or deny the change and/or to present a prompt to the user. As one example of the criteria, the EA model may be utilized to determine whether a change should be permitted or denied. The EA model collects and analyzes environment awareness information in connection with the various regions within the available environment where other AV output devices 112-116 are located. Based on the environment awareness information and the nature of the user instruction, the electronic device 102 determines whether, and to what extent, to implement the user instruction. For example, the EA model 102 may determine that the user has stepped outside away from other guest (based on device location information, motion information, sound information and the like). The users action of stepping away from other individuals in requesting an application to be open that is unrelated to the existing music/video application, indicates that the sports application should be treated as private. Accordingly, the EA model may simply deny the request to open the second application, providing notice only prompt and/or provide a notice-response prompt before opening the sports application.

In the foregoing example, the analysis of the context awareness information, and determination of which electronic devices to include, is performed at the “local” electronic device 102 that receives the verbal user instruction. Optionally, the analysis and determination may be performed at one or more other electronic devices 112-116, and/or remotely at a remote network resource (e.g., 118 in FIG. 1).

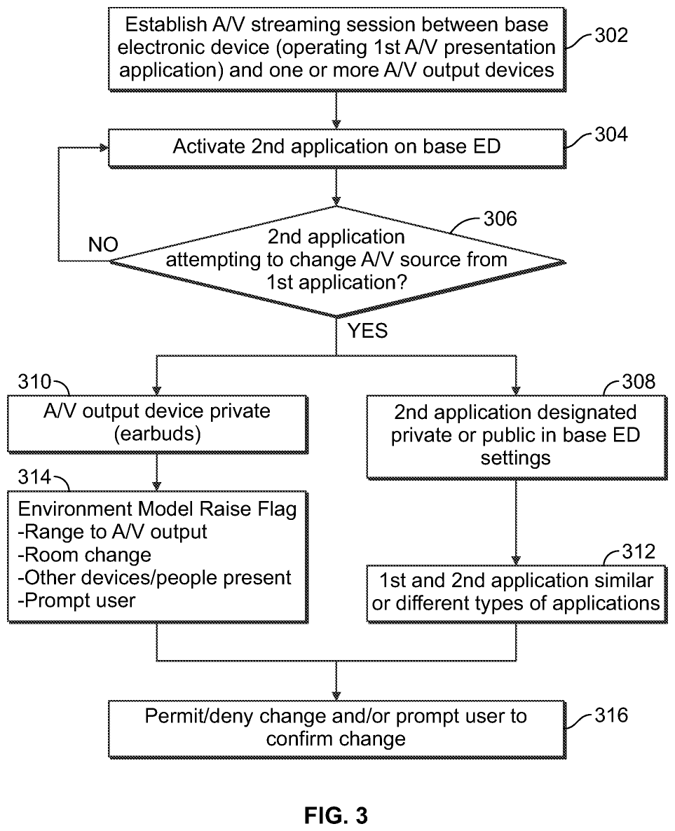

FIG. 3 illustrates a process for managing AV sources during screaming operations in accordance with embodiments herein. At 302, one or more processors of an electronic device operate a first application that provides a first AV source. For example, the first AV source may merely represent an audio source, such as music being played by a Spotify application and the like. The one or more processors of the ED establish an AV streaming session between the base electronic device and one or more AV output devices. For example, the AV output device may represent a Bluetooth speaker, home stereo system, smart TV, digital personal assistant and the like.

At 304, the one or more processors access a second application on the base ED. The second application may be configured to provide a second AV source (different from the AV source streamed at 302). For example, the user of the base ED may open or otherwise activate another application, such as to view an audio and/or video recording from Instagram, YouTube, ESPN, and the like.

At 306, the one or more processors of the base ED identify whether an attempt is made by the second application, to change the AV content, streaming from the ED, from the first AV source associated with the first application to the second AV source associated with the second application. For example, the second application may attempt to change the AV source presented through the base ED and similarly streamed from the ED. For example, the user may view a text, email or other message that includes a picture, video recording, audio recording or other link to AV content. When the user opens the text, the user may then select the content, in response to which, the one or more processors attempts to display the AV content.

When the identification at 306 determines that the second application would not result in a change in the AV source, flow returns to 304. For example, flowed move from 306 to 304 when the second application performs non-AV content related operations, such as simply displaying text, playing a game, enabling navigation through a webpage or other network resource and the like. Alternatively, when the identification at 306 determines that the second application would result in a change in the AV source, flow continues to one or more of the operations at 308-314. The operations at 308-314 may be performed in total or partially to determine whether to permit or deny a change to the second AV source based on various criteria. Each of the operations at 308-314 consider different types of criteria. For example, the operations at 308 and 312 may be implemented, but not the operations at 310 and 314. Additionally or alternatively any permutation or combination of the operations at 308-314 may be performed.

At 308, the one or more processors determine whether the second AV application is designated, in the settings of the ED, to be a private or public type of AV application. For example, when a new application is added to the ED, or any time thereafter, a user may be afforded the opportunity to designate/flag the application as a private or public type of application. The designation of private or public may be designated only in connection with audio output, only in connection with video output, or for both audio and video output. For example, music applications can be considered public, such that no prompt is necessary to the user when switching between music applications (e.g., switching between Pandora and Spotify applications).

At 310, the one or more processors determine whether the first and second applications are a different type or similar type of application. For example, the Soundcloud® application, Apple Music® application, Pandora® application and Spotify® applications represent a common type of application, namely a music or podcast application. In contrast, the Soundcloud® application, Apple Music® application, Pandora® application and Spotify® differ from the YouTube® application, Instagram® application, and Facebook® applications.

At 312, the one or more processors determine whether the one or more AV output devices are a private type of output device. For example, the AV output device may represent a set of Bluetooth enabled earbuds, headphones, and the like, which would be considered a private type of output device. As an alternative, the AV output device may represent a Bluetooth® speaker, Sonos® system, Alexa® DPA device and the like, which would be considered a public type of output device.

At 314, the one or more processors determine whether an environmental model indicates that the change should be permitted or denied. For example, the environmental model may take in consideration a range or distance between the base ED and the AV output device. Additionally or alternatively, the environmental model may take in consideration whether the base ED (and its user) have moved to a different room separate from the room or rooms in which the AV output device(s) are playing. Additionally or alternatively, the environmental model may take in consideration whether other devices (and corresponding users) are present within the environment in which the output of the AV output devices may be seen or heard. Additionally or alternatively, the environmental model may include (and optionally be limited to) presenting a prompt or warning message on the user interface of the base ED. The prompt may indicate that the AV source is about to change to present AV content associated with the second application. The prompt may request a user input to permit or deny the change.

Once the criteria are determined at one or more of 308-314, flow continues to 316. At 316, the one or more processors manage the streaming session to either maintain the first AV source or to change to the second AV source based on the determined criteria. As a nonlimiting example, at 308, the one or more processors may determine that the second application has been assigned a private type, and therefore at 316, the change may be denied without any further analysis or request for confirmation.

Additionally or alternatively, at 316, the one or more processors may present a prompt on a graphical user interface (GUI) of the ED based on the determinations at one or more of 308-314. The prompt may represent a notice-only prompt or a notice-response prompt. For example, a notice-response prompt may request an input from the user before an option to permit or deny the change. As another example, a notice-only prompt may be presented on the GUI such as presenting a warning message on the GUI of the ED. Additionally or alternatively, the warning message may identify the AV source for the ED that is about to be used. Additionally or alternatively, the notice-only prompt may identify the AV output device(s) that will output the AV content from the new AV source.

For example, when a user opens a second/new application such as a sports app, answering a call, checking a social media account, the prompt may say “Are you sure you want to open [x] and stop streaming Spotify music”. As another example, the prompt may indicate “The [Instagram][Facetime] app is designated private, do you want to share the AV content from the [Instagram][Facebook] app on the Bluetooth Speaker?” Optionally, the selection between a notice-only prompt and a notice-response prompt may be determined based on the private/public designation of the second application. For example, when the second application is designated to be a public type, the prompt may be a notice-only prompt, whereas, when the second application is designated to be a private type, the prompt may be a notice-response prompt.

Additionally or alternatively, the determinations at 308-314 may be assigned a priority, such that one type of criteria takes precedent over another. For example, at 308 the second application may be assigned a private setting, but at 310, it may be determined that the AV output device is only a set of earbuds. In the foregoing example, the one or more processors would permit the change at 316 without any further prompt or warning. As another example, at 312, it may be determined that the first and second applications are of a similar type, and at 314, it may be determined that the base ED is no longer in the same room as the AV output device and multiple third-party ED are present (indicating that multiple third parties are present) in the area surrounding the AV output device. The determination at 314 may be assigned a priority over the determination at 312. Thus, 316, the one or more processors may deny the change to the second AV source and/or prompt the user to confirm whether the changes authorized.

The content and nature of the audio content may vary based on various factors. For example, the content may be conveyed in accordance with a Bluetooth protocol. Optionally, the content may be conveyed in accordance with various wireless protocols, such as 802.11, wireless local area network (WLAN), Wi-Fi protected access (WPA), wired equivalent privacy (WEP), Wi-Fi, wireless broadband and the like. As other examples, the content may be conveyed in accordance with various communications protocols, such as a hypertext transfer protocol (HTTP), Internet relay chat (IRC) and the like.

### Closing

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

Aspects are described herein with reference to the figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified. The program instructions may also be stored in a device readable medium that can direct a device to function in a particular manner, such that the instructions stored in the device readable medium produce an article of manufacture including instructions which implement the function/act specified. The instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the units/modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the units/modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

1. A method, comprising:
under control of one or more processors configured with executable instructions that include first and second applications;
operating the first application on an electronic device (ED), the first application providing a first audio/video (AV) source;
establishing a streaming session between the ED and one or more AV output devices, the streaming session streaming AV content, to the one or more AV output devices, from the first AV source designated by the first application operating on the ED;
accessing the second application on the ED, the second application providing a second AV source;
identifying an attempt, by the second application, to change the AV content from the first AV source associated with the first application to the second AV source associated with the second application;
denying the change to the second AV source in response to identifying the attempt, by the second application, to change the AV content from the first AV source to the second AV source; and
managing the streaming session to maintain the first AV source based on the determining operation.

2. The method of claim 1, further comprising displaying at least one of: 1) a notice-only prompt or 2) a notice-response prompt on a graphical user interface of the ED, the notice-only prompt presenting a message indicative of the change to the second AV source, the notice-response prompt including a response field for an input to permit or deny the change.

3. The method of claim 1, wherein the denying operation includes determining that the second AV application is designated to be private in settings of the ED, and based thereon, the managing operation maintaining the first AV source and denying the change to the second AV source.

4. The method of claim 1, wherein the denying operation includes determining that the first and second applications are different, and based thereon, the managing operation maintaining the first AV source and denying the change to the second AV source.

5. The method of claim 1, wherein the denying operation includes determining that the one or more AV output devices are a designated as private in settings of the ED, and based thereon, the managing operation including denying the change to the second AV source.

6. The method of claim 1, wherein the denying operation includes determining that an environmental awareness model indicates that the change should be denied, and based thereon, the managing operation maintaining the first AV source and denying the change to the second AV source.

7. The method of claim 1, wherein the AV content includes only audio content, with no video content.

8. The method of claim 1, wherein the AV content includes only video content, with no audio content.

9. An electronic device, comprising:
a processor;
a user interface;
a data storage device having executable instructions and first and second applications accessible by the processor;
wherein, responsive to execution of the instructions, the processor to:
operate the first application to provide a first audio/video (AV) source;
establish a streaming session between the ED and one or more AV output devices, the streaming session streaming AV content, to the one or more AV output devices, from the first AV source designated by the first application;
access the second application having a second AV source;
identify an attempt, by the second application, to change from the first AV source associated with the first application to the second AV source associated with the second application;
deny the change to the second AV source in response to identifying the attempt, by the second application, to change the AV content from the first AV source to the second AV source; and
manage the streaming session to maintain the first AV source based on the determining operation.

10. The device of claim 9, wherein the user interface is configured to display at least one of: 1) a notice-only prompt or 2) a notice-response prompt on a graphical user interface of the ED, the notice-only prompt presenting a message indicative of the change to the second AV source, the notice-response prompt including a response field for an input to permit or deny the change.

11. The device of claim 9, wherein the executable instructions are executable by the processor to determine that the second AV application is designated to be private in settings of the ED, and based thereon, to maintain the first AV source and denying the change to the second AV source.

12. The device of claim 9, wherein the executable instructions are executable by the processor to determine that the first and second applications are different, and based thereon, to maintain the first AV source and denying the change to the second AV source.

13. The device of claim 9, wherein the executable instructions are executable by the processor to determine that the one or more AV output devices are designated as private in settings of the ED, and based thereon, to deny the change to the second AV source.

14. The device of claim 9, wherein the executable instructions are executable by the processor to determine that an environmental awareness model indicates that the change should be denied, and based thereon, to maintain the first AV source and deny the change to the second AV source.

15. The device of claim 9, wherein the AV content includes only audio content, with no video content.

16. A non-signal readable data storage device comprising executable code to:
operate a first application to provide a first audio/video (AV) source;
establish a streaming session between the ED and one or more AV output devices, the streaming session streaming AV content, to the one or more AV output devices, from the first AV source designated by the first application;
access the second application having a second AV source;
identify an attempt, by the second application, to change from the first AV source associated with the first application to a second AV source associated with the second application;
deny the change to the second AV source based on at least one of the following criteria: i) whether the first and second applications are different, or ii) whether an environment awareness model indicates that the change should be permitted or denied, and in response to identifying the attempt, by the second application, to deny the change of the AV content from the first AV source to the second AV source; and
manage the streaming session to maintain the first AV source based on the determining operation.

17. The computer program product of claim 16, further comprising executable code to display at least one of: 1) a notice-only prompt or 2) a notice-response prompt on a graphical user interface of the ED, the notice-only prompt presenting an identification of the one or more AV output devices that will output the AV content from the second AV source, the notice-response prompt including a response field for an input to permit or deny the change.

18. The computer program product of claim 16, further comprising executable code to determine that the second AV application is designated to be private in settings of the ED, and based thereon, the manage operation to maintain the first AV source and denying the change to the second AV source.

19. The computer program product of claim 16, further comprising executable code to determine that the first and second applications are different, and based thereon, to maintain the first AV source and denying the change to the second AV source.

20. The computer program product of claim 16, further comprising executable code to determine that the environmental awareness model indicates that the change should be denied, and based thereon, to maintain the first AV source and deny the change to the second AV source.
